(19) United States
(12) Patent Application Publication
(10) Pub. No.: US 2007/0271274 A1
(43) Pub. Date: Nov. 22, 2007

(54) Using a community generated web site for metadata

(76) Inventors: Khemdut Purang, San Jose, CA (US); Mark Plutowski, Santa Cruz, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/436,011

(22) Filed: May 16, 2006

(51) Int. Cl. G06F 17/30

(52) U.S. Cl. 707/10

(57) ABSTRACT

A category dataset includes names of categories and relation data, where the relation data defines a relationship between the categories and content. The categories for the content are generated by retrieving a web page from a an online community generated web site, such as the, WIKIPEDIA web site, associated with a particular piece of content and analyzing the web page for content metadata. The category data for that piece of content is extracted from the content metadata. In addition, the terms in category dataset are reduced based on the categories and the relation data.

### RELATED APPLICATIONS

This patent application is related to the co-pending U.S. patent application, entitled “______”, application Ser. No. ______, attorney docket no. 80398.P649, and co-pending U.S. patent application, entitled “DIMENSIONALITY REDUCTION FOR CONTENT CATEGORY DATA”, application Ser. No. ______, attorney docket no. 80398.P655. The related co-pending applications are assigned to the same assignee as the present application.

### TECHNICAL FIELD

This invention relates generally to multimedia, and more particularly using community generated data sources to generate multimedia metadata.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright© 2005, Sony Electronics, Incorporated, All Rights Reserved.

### BACKGROUND

Clustering and classification tend to be important operations in certain data mining applications. For instance, data within a dataset may need to be clustered and/or classified in a data system with a purpose of assisting a user in searching and automatically organizing content, such as recorded television programs, electronic program guide entries, and other types of multimedia content.

Generally, many clustering and classification algorithms work well when the dataset is numerical (i.e., when datum within the dataset are all related by some inherent similarity metric or natural order). Numerical datasets often describe a single attribute or category. Categorical datasets, on the other hand, describe multiple attributes or categories that are often discrete, and therefore, lack a natural distance or proximity measure between them.

### SUMMARY

A category dataset includes names of categories and relation data, where the relation data defines a relationship between the categories and content. The categories for the content are generated by retrieving a web page from an online community generated web site, such as the, WIKIPEDIA web site, associated with a particular piece of content and analyzing the web page for content metadata. The category data for that piece of content is extracted from the content metadata. In addition, the terms in category dataset are reduced based on the categories and the relation data.

The present invention is described in conjunction with systems, clients, servers, methods, and machine-readable media of varying scope. In addition to the aspects of the present invention described in this summary, further aspects of the invention will become apparent by reference to the drawings and by reading the detailed description that follows.

### BRIEF DESCRIPTION OF THE DRAWINGS

The present invention is illustrated by way of example and not limitation in the figures of the accompanying drawings in which like references indicate similar elements.

FIG. 1A illustrates one embodiment of a multimedia database system.

FIG. 1B illustrates one embodiment of content metadata.

FIG. 2 is a flow chart of one embodiment of a method for creating metadata for a content from a community-generated web site.

FIG. 3 is a flow chart of one embodiment of a method for retrieving a content web page for use with the method at FIG. 3.

FIG. 4 is a flow chart of one embodiment of a method to parse the content web page for use with the method at FIG. 3.

FIG. 5 is a block diagram illustrating one embodiment of a device that creates content metadata from a community-generated web site.

FIG. 6 is a diagram of one embodiment of an operating environment suitable for practicing the present invention.

FIG. 7 a diagram of one embodiment of a computer system suitable for use in the operating environment of FIGS. 2-4.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

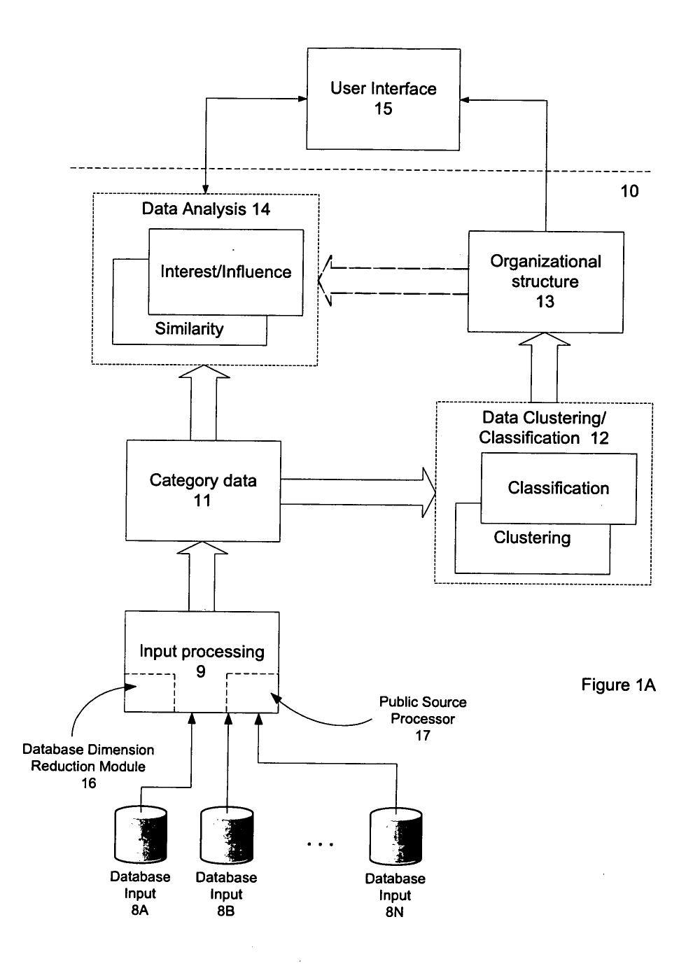

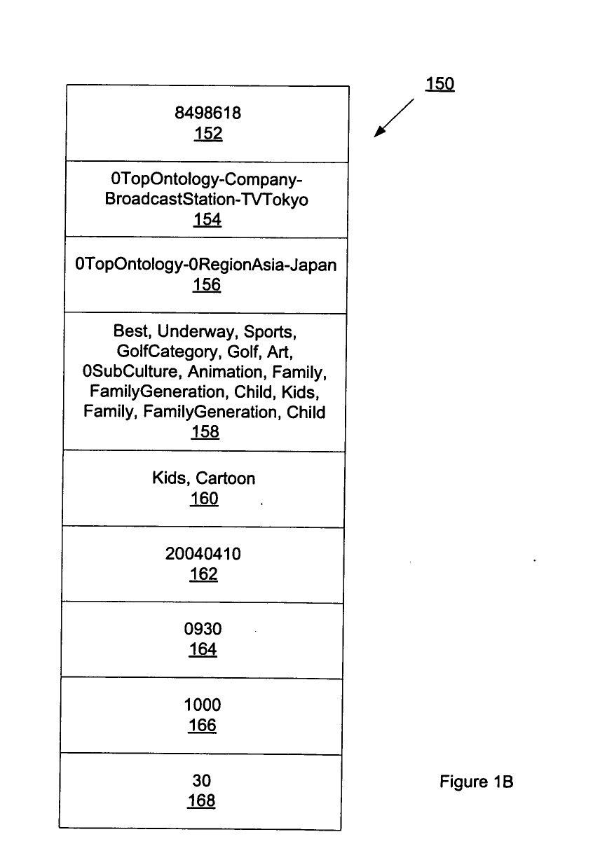

FIG. 1A is a diagram of a data system 10 that enables automatic recommendation or selection of information, such as content, which can be characterized by category data 11. Category data, also referred to as category dataset, describes multiple attributes or categories. Each category comprises category names and relation data, where the relation data define the relationship between the category and one or more particular pieces of content. The word “term” referred to herein is a category name. In one embodiment, category data has a dimension based on the number of terms and the term relations. The more terms and/or term relations in category data, the greater the dimensionality of category data. Conversely, reducing the number of terms and/or term relations, the smaller the dimensionality of the category data.

Furthermore, category data can be sparse, which means that the category data has a large dimensionality. In one embodiment, the category data is sparse because the categories are discrete and lack a natural similarity measure between them. Examples of category data include electronic program guide (EPG) data, and content metadata. The data system 10 includes an input processing module 9 to preprocess and load the category data 11 from database input 8A-N. In one embodiment, database input 8A-N can be one of several community-generated sources, such as WIKIPEDIA, etc.

The category data 11 is grouped into clusters, and/or classified into folders by the clustering/classification module 12. Details of the clustering and classification performed by module 12 are below. The output of the clustering/classification module 12 is an organizational data structure 13, such as a cluster tree or a dendrogram. A cluster tree may be used as an indexed organization of the category data or to select a suitable cluster of the data.

Many clustering applications require identification of a specific layer within a cluster tree that best describes the underlying distribution of patterns within the category data. In one embodiment, organizational data structure 13 includes an optimal layer that contains a unique cluster group containing an optimal number of clusters.

A data analysis module 14 may use the folder-based classifiers and/or classifiers generated by clustering operations for automatic recommendation or selection of content. The data analysis module 14 may automatically recommend or provide content that may be of interest to a user or may be similar or related to content selected by a user. In one embodiment, a user identifies multiple folders of category data records that categorize specific content items, and the data analysis module 14 assigns category data records for new content items with the appropriate folders based on similarity.

A user interface 15 also shown in FIG. 1A is designed to assist the user in searching and automatically organizing content using the data system 10. Such content may be, for example, recorded TV programs, electronic program guide (EPG) entries, and multimedia content.

Clustering is a process of organizing category data into a plurality of clusters according to some similarity measure among the category data. The module 12 clusters the category data by using one or more clustering processes, including seed based hierarchical clustering, order-invariant clustering, and subspace bounded recursive clustering. In one embodiment, the clustering/classification module 12 merges clusters in a manner independent of the order in which the category data is received.

In one embodiment, the group of folders created by the user may act as a classifier such that new category data records are compared against the user-created group of folders and automatically sorted into the most appropriate folder. In another embodiment, the clustering/classification module 12 implements a folder-based classifier based on user feedback. The folder-based classifier automatically creates a collection of folders, and automatically adds and deletes folders to or from the collection. The folder-based classifier may also automatically modify the contents of other folders not in the collection.

In one embodiment, the clustering/classification module 12 may augment the category data prior to or during clustering or classification. One method for augmentation is by imputing attributes of the category data. The augmentation may reduce any scarceness of category data while increasing the overall quality of the category data to aid the clustering and classification processes.

Although shown in FIG. 1A as specific separate modules, the clustering/classification module 12, organizational data structure 13, and the data analysis module 14 may be implemented as different separate modules or may be combined into one or more modules.

As illustrated in FIG. 1A, Database input module 9 processes and loads information form databases 8-N into category dataset 11. Database input module 9 further comprises public source processor 17 that processes data available from the community-generated sources noted above. In one embodiment, public source processor 17 requests information for a particular piece of content and process the resulting information into a form that can be input into content metadata.

Database input module 9 further comprises database dimension reduction module 15. As stated above, category datasets can be sparse. Reducing the dimensionality of the datasets improves the efficiency and quality of modules using the datasets, because the datasets are denser and easier to search and/or process. In one embodiment, database dimension reduction module 15 reduces the dimensionality of category dataset 11 by modifying the term relations between the terms in category dataset 11 and the content. A term relation is data that define the relationship between a term in category data 11 and the one or more particular pieces of content associated with that term. In another embodiment, database dimension reduction module 15 reduces the dimensionality of category dataset 11 by reducing the number of terms in category dataset 11. A particular methodology for reducing category data dimensionality is described in the co-pending U.S. patent application, entitled “DIMENSIONALITY REDUCTION FOR CONTENT CATEGORY DATA”, application Ser. No. ______, attorney docket no. 80398.P655. As described in application Ser. No. ______, the category data dimensionality is reduced based on the category names in the category dataset and relation data, where the relation data defines a relationship between the category dataset and the content associated with the category dataset.

In one embodiment, database input module 9 extracts category data for a particular piece of content from content metadata. Content metadata is information that describes content used by data system 10. FIG. 1B illustrates one embodiment of content metadata 150 for a particular content processed by database input module 9. In FIG. 1B, content metadata 150 comprises program identifier 152, station broadcaster 154, broadcast region 156, category data 158, genre 160, date 162, start time 164, end time 166, and duration 168. Furthermore, content metadata 150 may include additional fields (not shown). Program identifier 152 identifies the content used by data system 10. Station broadcaster 154 and broadcast region 156 identify the broadcaster and the region where content was displayed. In addition, content metadata 150 identifies the date and time the content was displayed with date 162, start time 164, end time 166. Duration 168 is the duration of the content. Furthermore, genre describes the genre associated with the content.

Category data for a particular piece of content is one or more terms that describe the different categories associated with the piece of content. As illustrated in FIG. 1B, category data 158 comprises the terms: Best, Underway, Sports, GolfCategory, Golf, Art, 0SubCulture, Animation, Family, FamilyGeneration, Child, Kids, Family, FamilyGeneration, and Child. Thus, category data 158 comprises fifteen terms describing the program. Some of the terms are related, for example, “Sports, GolfCategory, Golf” are related to sports, and “Family, FamilyGeneration, Child, Kids”, are related to family. Furthermore, category data 158 includes duplicate terms and possibly undefined terms (0SubCulture). Undefined terms are associated with one program, because the definition is unknown.

One problem with generating accurate and up to date content 150 is maintaining the large amount of content. For example, a week of television programming could have thousands of programs with thousands of individual terms describing the programs. One possible way to reduce the cost and time to maintain a large amount of content data is to extract content metadata from community-generated web sites, such as a wiki-based web site. A wiki based web site is a multilingual Web-based free-content encyclopedia that allows users to easily add and edit content. An example is the publicly available WIKIPEDIA service. Thus, the wiki encyclopedia is written collaboratively by many users, allowing most articles to be edited by anyone with a web browser. This can allow for a relatively inexpensive way to generate metadata for content.

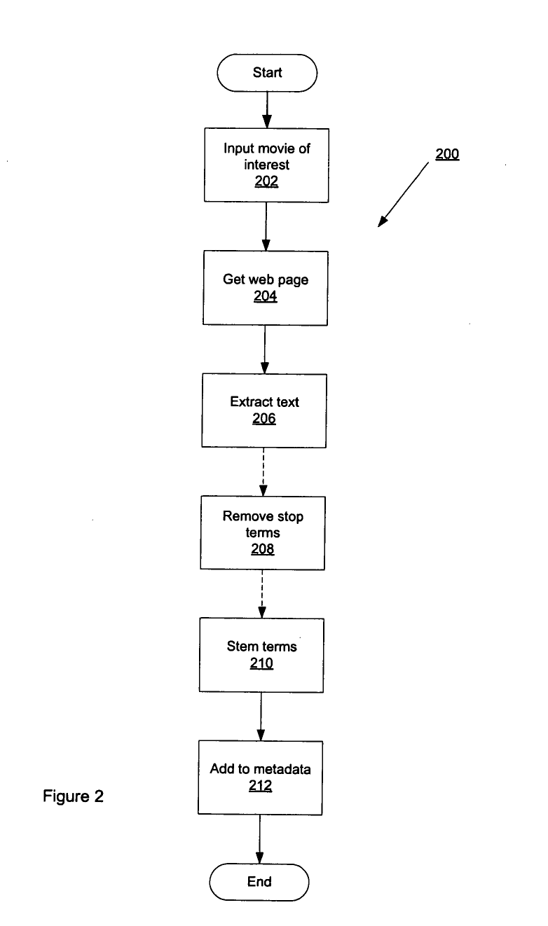

FIG. 2 is a flow chart of one embodiment of a method 200 for creating content metadata from a community-generated web site. In one embodiment, method 200 retrieves content information from a wiki type of website. In alternate embodiments, method 200 retrieves content information from other community or commercial web sites, such as, WIKIPEDIA, GRACENOTE, IMDB, MOODLOGIC, ROTTEN TOMATOES, AMG, AMAZON, etc.

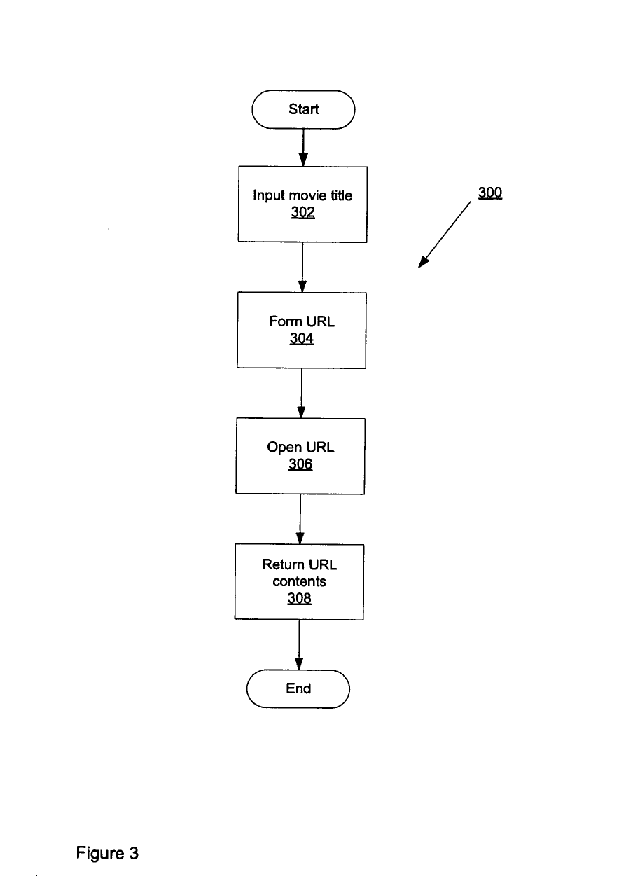

Method 200 can take advantage of the information contained in a wiki by harvesting the information through web retrievals. At block 202, method 200 receives information about the content of the interest. For example, in one embodiment, method 200 receives the title, genre, and information about the actors, actresses, producer, director, etc.). Based on the content information received, method 200 retrieves a web page associated with the content at block 204. One embodiment of web retrieval is further described in FIG. 3, below.

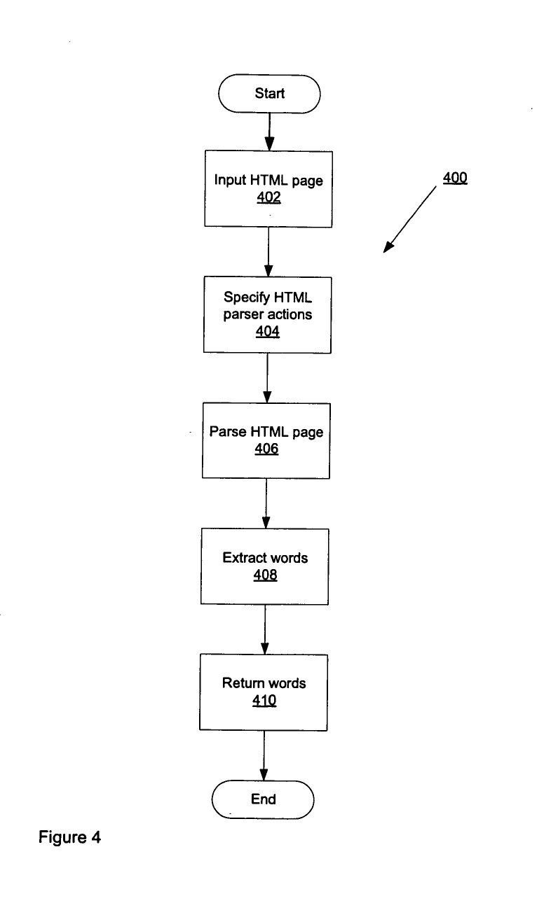

At block 206, method 200 extracts the text from the retrieved web page. Text extraction extract terms that describe or are associated with the content of interest. One embodiment text extraction is further described in FIG. 4, below.

Optionally, at block 208, method 200 removes the stop terms from the extracted text. In one embodiment, stop terms are punctuation that delineate sentences, clauses, etc. Alternatively, stop term can include other marks, such as a, the, an, of, in, but, or, etc. By removing the stop terms, the extracted text is left with terms associated with the content and other non-stop terms.

Optionally, at block 210, method 200 removes the stem terms from the extracted text using one of the stemming algorithms well-known in the art, such as, but not limited to Paice/Husk, Porter, Lovins, Dawson, Krovetz, etc. Stemming reduces a term to its stem or root form. For example, the words “computing” and “computation” have the stem “compute”. Stemming term further reduces the variants of terms in the extracted text so that stemming can reduce the number of terms in the extracted text.

At block 212, method 200 adds terms from the modified extracted text to the metadata for that content. For example, method 200 extract terms about the content's genre, actors, actresses, awards, producers, directors, reviews, links to further information, etc. In one embodiment, method 200 adds the extracted terms to category data. In this embodiment, method 200 adds the extracted terms to category data 11 that are useful to categorize the content, such as, but not limited to genre, actors, actresses, awards, producers, directors, etc. Alternatively, method 200 can catergorize the data. In alternate embodiments, method 200 adds terms to a separate metadata database used to store content metadata.

FIG. 3 is a flow chart of one embodiment of a method 300 for retrieving a content web page. At block 302, method 300 receives information about the content of the interest. For example, in one embodiment, method 300 receives the content title, genre, length of content, year produced, and information about actors, actresses, producer, director, etc. Based on the information received, method 300 forms a uniform resource locator (URL) for the content. For example, if method 300 retrieves information about “Star Wars IV: A New Hope” from the public WIKIPEDIA, method 300 creates a URL based on the source (“en.wikipedia.org/wiki/”) and the title (“Star_Wars_Episode_IV:_A_New_Hope”). Each community source can have its own format that is used for access.

At block 306, method 300 opens the URL formed in block 304. While in one embodiment, method 306 opens the URL by making a Hypertext transfer protocol (HTTP) request, in alternate embodiments, method 300 opens the URL using different protocols (secure HTTP (HTTPS), etc.). Method 308 returns the URL contents at block 308.

FIG. 4 is a flow chart of one embodiment of a method 400 to parse the content web page. At block 404, method 400 receives the web page. In one embodiment, the web page is an hypertext markup language (HTML) page. Alternatively, the web page may be a different type of text format known in the art (Extended HTML (XHTML), extended markup language (XML), standard generalized markup language (SGML), etc.).

At block 404, method 400 specifies the HTML parser actions. Parser action define how the HTML parser extracts words from the received web page. For example, method 400 could specify to remove all text within HTML tags, remove all HTML tags except for the HTML “META” tag, to ignore words starting with a number, etc. Furthermore, in another embodiment, method 400 could specify parser actions based on other types of formats (XHTML, XML, SGML, etc.). Based on the specified parser actions, method 400 parses the HTML page into separate words at block 406 using an algorithm known in the art, such as, parser actions known in the art, such as splitting terms at white space (except for cases such as “Mr. X”, “Joe Public”, etc.). At block 408, method 400 extracts the first N words from the parsed HTML page. In one embodiment, N is a rough limit on words. Alternatively, N can be a limit on the number of paragraphs processed, such as, selecting words from the first N paragraphs of text. Limiting the number of words extracted helps maintain a smaller size of category data because the metadata extracted is used as input into category data 11. Alternatively, method 400 extracts all the words from the parsed HTML page.

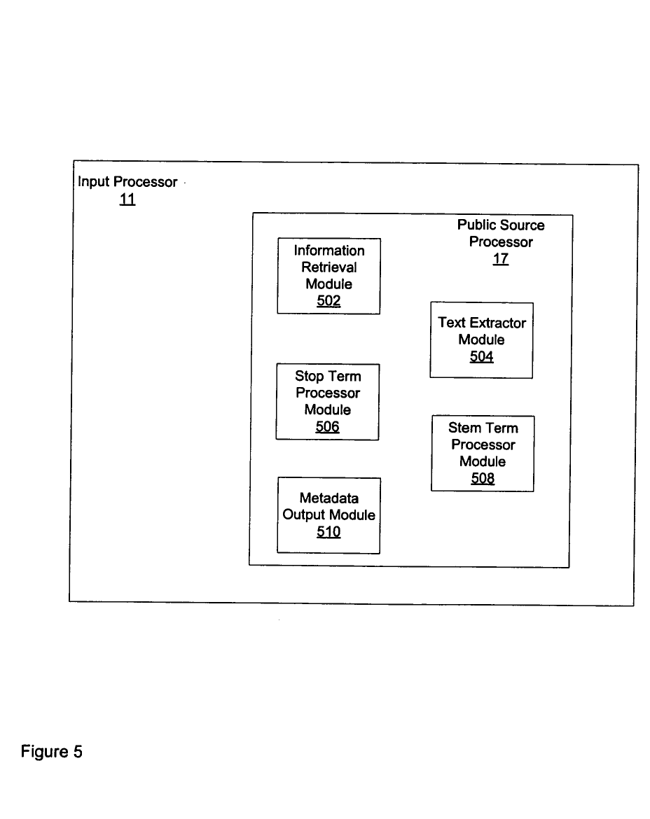

FIG. 5 is a block diagram illustrating one embodiment of a device that creates content metadata from a community-generated web site. In one embodiment, input processor 11 contains public source processor 17. Alternatively, input processor 11 does not contain public source processor 17, but is coupled to public source processor 17. Public source processor 17 comprises information retrieval module 502, text extractor module 504, stop term processor module 506, stem term processor module 508, and metadata output module 510. Information retrieval module 502 retrieves information from a community-generated source about a particular piece of content as described in FIG. 2, block 204. Text extractor module 504 extracts terms from the requested information as described in FIG. 2, block 206. Stop term processor module 506 removes stop terms from the extracted terms as described in FIG. 2, block 208. Stem term processor module 506 processes the extracted terms into associated stem terms as described in FIG. 2, block 210. Metadata output module 510 adds the extracted terms to the metadata for the particular piece of content as described in FIG. 2, block 212.

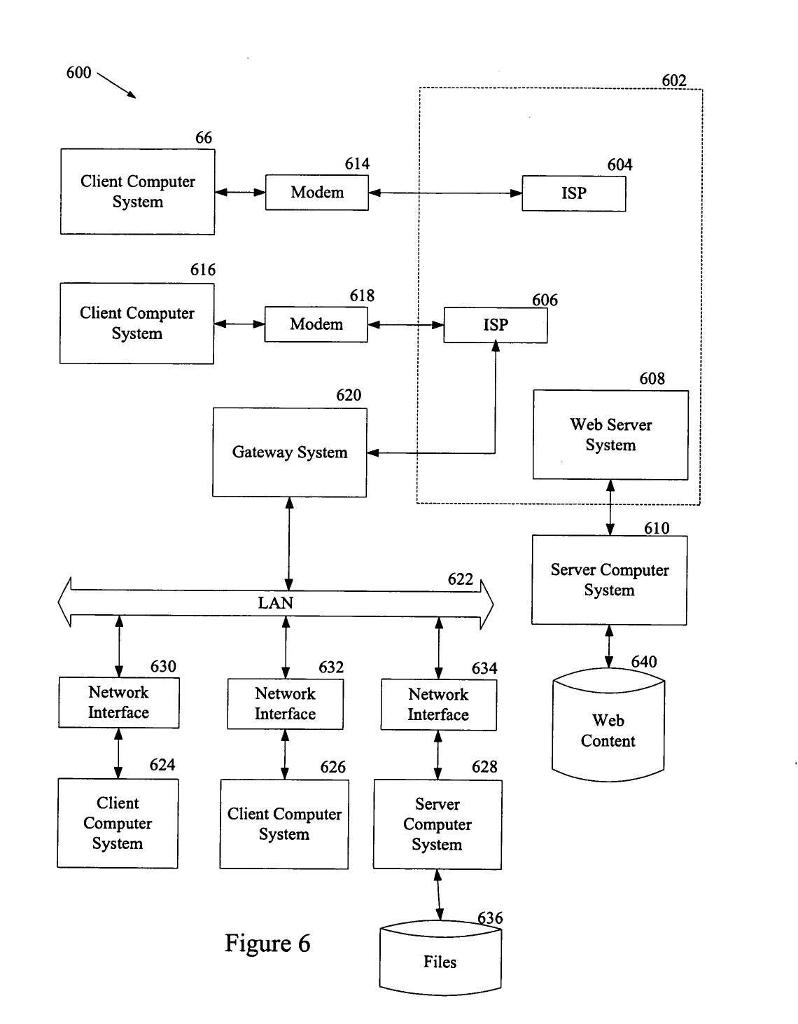

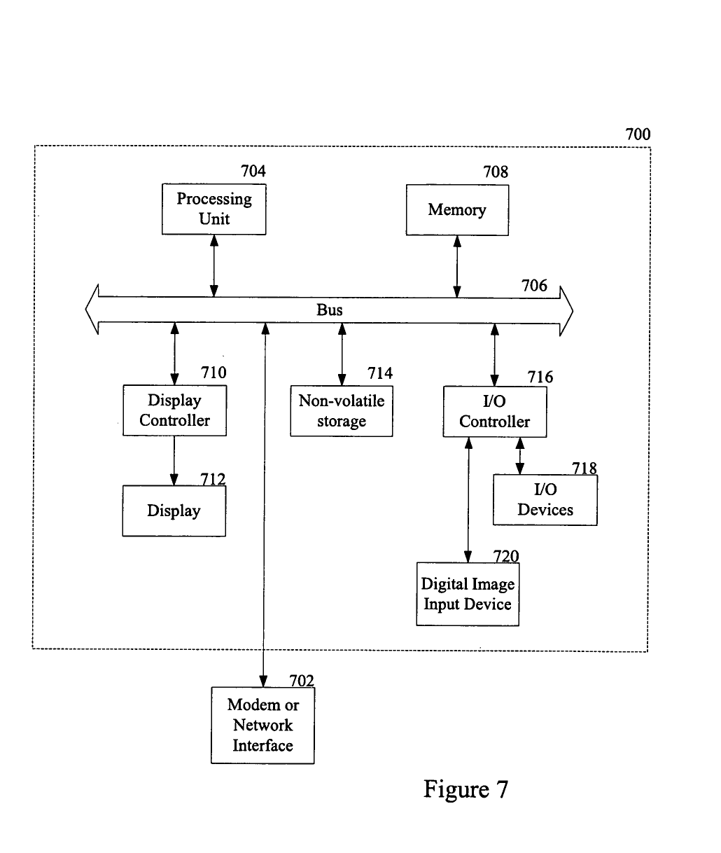

The following descriptions of FIGS. 6-7 is intended to provide an overview of computer hardware and other operating components suitable for performing the methods of the invention described above, but is not intended to limit the applicable environments. One of skill in the art will immediately appreciate that the embodiments of the invention can be practiced with other computer system configurations, including hand-held devices, multiprocessor systems, microprocessor-based or programmable consumer electronics, network PCs, minicomputers, mainframe computers, and the like. The embodiments of the invention can also be practiced in distributed computing environments where tasks are performed by remote processing devices that are linked through a communications network, such as peer-to-peer network infrastructure.

In practice, the methods described herein may constitute one or more programs made up of machine-executable instructions. Describing the method with reference to the flowchart in FIGS. 2-4 enables one skilled in the art to develop such programs, including such instructions to carry out the operations (acts) represented by logical blocks on suitably configured machines (the processor of the machine executing the instructions from machine-readable media). The machine-executable instructions may be written in a computer programming language or may be embodied in firmware logic or in hardware circuitry. If written in a programming language conforming to a recognized standard, such instructions can be executed on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic . . . ), as taking an action or causing a result. Such expressions are merely a shorthand way of saying that execution of the software by a machine causes the processor of the machine to perform an action or produce a result. It will be further appreciated that more or fewer processes may be incorporated into the methods illustrated in the flow diagrams without departing from the scope of the invention and that no particular order is implied by the arrangement of blocks shown and described herein.

FIG. 6 shows several computer systems 600 that are coupled together through a network 602, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (web). The physical connections of the Internet and the protocols and communication procedures of the Internet are well known to those of skill in the art. Access to the Internet 602 is typically provided by Internet service providers (ISP), such as the ISPs 604 and 606. Users on client systems, such as client computer systems 612, 616, 624, and 626 obtain access to the Internet through the Internet service providers, such as ISPs 604 and 606. Access to the Internet allows users of the client computer systems to exchange information, receive and send e-mails, and view documents, such as documents which have been prepared in the HTML format. These documents are often provided by web servers, such as web server 608 which is considered to be “on” the Internet. Often these web servers are provided by the ISPs, such as ISP 604, although a computer system can be set up and connected to the Internet without that system being also an ISP as is well known in the art.

The web server 608 is typically at least one computer system which operates as a server computer system and is configured to operate with the protocols of the World Wide Web and is coupled to the Internet. Optionally, the web server 608 can be part of an ISP which provides access to the Internet for client systems. The web server 608 is shown coupled to the server computer system 610 which itself is coupled to web content 640, which can be considered a form of a media database. It will be appreciated that while two computer systems 608 and 610 are shown in FIG. 6, the web server system 608 and the server computer system 610 can be one computer system having different software components providing the web server functionality and the server functionality provided by the server computer system 610 which will be described further below.

Client computer systems 612, 616, 624, and 626 can each, with the appropriate web browsing software, view HTML pages provided by the web server 608. The ISP 604 provides Internet connectivity to the client computer system 612 through the modem interface 614 which can be considered part of the client computer system 612. The client computer system can be a personal computer system, a network computer, a Web TV system, a handheld device, or other such computer system. Similarly, the ISP 606 provides Internet connectivity for client systems 616, 624, and 626, although as shown in FIG. 6, the connections are not the same for these three computer systems. Client computer system 616 is coupled through a modem interface 618 while client computer systems 624 and 626 are part of a LAN. While FIG. 6 shows the interfaces 614 and 618 as generically as a “modem,” it will be appreciated that each of these interfaces can be an analog modem, ISDN modem, cable modem, satellite transmission interface, or other interfaces for coupling a computer system to other computer systems. Client computer systems 624 and 616 are coupled to a LAN 622 through network interfaces 630 and 632, which can be Ethernet network or other network interfaces. The LAN 622 is also coupled to a gateway computer system 620 which can provide firewall and other Internet related services for the local area network. This gateway computer system 620 is coupled to the ISP 606 to provide Internet connectivity to the client computer systems 624 and 626. The gateway computer system 620 can be a conventional server computer system. Also, the web server system 608 can be a conventional server computer system.

Alternatively, as well-known, a server computer system 628 can be directly coupled to the LAN 622 through a network interface 634 to provide files 636 and other services to the clients 624, 626, without the need to connect to the Internet through the gateway system 620. Furthermore, any combination of client systems 612, 616, 624, 626 may be connected together in a peer-to-peer network using LAN 622, Internet 602 or a combination as a communications medium. Generally, a peer-to-peer network distributes data across a network of multiple machines for storage and retrieval without the use of a central server or servers. Thus, each peer network node may incorporate the functions of both the client and the server described above.

FIG. 7 shows one example of a conventional computer system that can be used as encoder or a decoder. The computer system 700 interfaces to external systems through the modem or network interface 702. It will be appreciated that the modem or network interface 702 can be considered to be part of the computer system 700. This interface 702 can be an analog modem, ISDN modem, cable modem, token ring interface, satellite transmission interface, or other interfaces for coupling a computer system to other computer systems. The computer system 702 includes a processing unit 704, which can be a conventional microprocessor such as an Intel Pentium microprocessor or Motorola Power PC microprocessor. Memory 708 is coupled to the processor 704 by a bus 706. Memory 708 can be dynamic random access memory (DRAM) and can also include static RAM (SRAM). The bus 706 couples the processor 704 to the memory 708 and also to non-volatile storage 714 and to display controller 710 and to the input/output (I/O) controller 716. The display controller 710 controls in the conventional manner a display on a display device 712 which can be a cathode ray tube (CRT) or liquid crystal display (LCD). The input/output devices 718 can include a keyboard, disk drives, printers, a scanner, and other input and output devices, including a mouse or other pointing device. The display controller 710 and the I/O controller 716 can be implemented with conventional well known technology. A digital image input device 720 can be a digital camera which is coupled to an I/O controller 716 in order to allow images from the digital camera to be input into the computer system 700. The non-volatile storage 714 is often a magnetic hard disk, an optical disk, or another form of storage for large amounts of data. Some of this data is often written, by a direct memory access process, into memory 708 during execution of software in the computer system 700. One of skill in the art will immediately recognize that the terms “computer-readable medium” and “machine-readable medium” include any type of storage device that is accessible by the processor 704 and also encompass a carrier wave that encodes a data signal.

Network computers are another type of computer system that can be used with the embodiments of the present invention. Network computers do not usually include a hard disk or other mass storage, and the executable programs are loaded from a network connection into the memory 708 for execution by the processor 704. A Web TV system, which is known in the art, is also considered to be a computer system according to the embodiments of the present invention, but it may lack some of the features shown in FIG. 7, such as certain input or output devices. A typical computer system will usually include at least a processor, memory, and a bus coupling the memory to the processor.

It will be appreciated that the computer system 700 is one example of many possible computer systems, which have different architectures. For example, personal computers based on an Intel microprocessor often have multiple buses, one of which can be an input/output (I/O) bus for the peripherals and one that directly connects the processor 704 and the memory 708 (often referred to as a memory bus). The buses are connected together through bridge components that perform any necessary translation due to differing bus protocols.

It will also be appreciated that the computer system 700 is controlled by operating system software, which includes a file management system, such as a disk operating system, which is part of the operating system software. One example of an operating system software with its associated file management system software is the family of operating systems known as Windows® from Microsoft Corporation of Redmond, Wash., and their associated file management systems. The file management system is typically stored in the non-volatile storage 714 and causes the processor 704 to execute the various acts required by the operating system to input and output data and to store data in memory, including storing files on the non-volatile storage 714.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computerized method comprising:
receiving a web page from a community-generated web site, the web page associated with a particular piece of content;
extracting a plurality of terms from the web page;
adding the plurality of terms to content metadata associated with the piece of content;
extracting specific category data from the content metadata;
loading the specific category data into a category dataset; and
reducing a dimensionality of the category dataset based on the category dataset and relation data, wherein the relation data defines a relationship between the category dataset and the content associated with the category dataset.

2. The computerized method of claim 1, wherein extracting the plurality of terms further comprises at least one of stemming the terms in the web page, removing the stop terms from the web page, and extracting a limited number of terms from the web page.

3. The computerized method of claim 1, wherein extracting the plurality of terms further comprises defining parser actions on the web page format.

4. The computerized method of claim 1, wherein the metadata is category data.

5. A machine readable medium comprising:
receiving a web page from a community-generated web site, the web page associated with a particular piece of content;
extracting a plurality of terms from the web page;
adding the plurality of terms to content metadata associated with the piece of content;
extracting specific category data from the content metadata;
loading the specific category data into a category dataset; and
reducing a dimensionality of the category dataset based on the category dataset and relation data, wherein the relation data defines a relationship between the category dataset and the content associated with the category dataset.

6. The machine readable medium of claim 5, wherein extracting the plurality of terms further comprises at least one of stemming the terms in the web page, removing the stop terms from the web page, and extracting a limited number of terms from the web page.

7. The machine readable medium of claim 5, wherein extracting the plurality of terms further comprises defining parser actions on the web page format.

8. The machine readable medium of claim 5, wherein the metadata is category data.

9. An apparatus comprising:
means for receiving a web page from a community-generated web site, the web page associated with a particular piece of content;
means for extracting a plurality of terms from the web page;
means for adding the plurality of terms to content metadata associated with the piece of content;
means for extracting specific category data from the content metadata;
means for loading the specific category data into a category dataset; and
means for reducing a dimensionality of the category dataset based on the category dataset and relation data, wherein the relation data defines a relationship between the category dataset and the content associated with the category dataset.

10. The apparatus of claim 9, wherein the means for extracting the plurality of terms further comprises at least one of stemming the terms in the web page, removing the stop terms from the web page, and extracting a limited number of terms from the web page.

11. The apparatus of claim 9, wherein the means for extracting the plurality of terms further comprises defining parser actions on the web page format.

12. The apparatus of claim 9, wherein the metadata is category data.

13. A system comprising:
a processor;
a memory coupled to the processor though a bus; and
a process executed from the memory by the processor to cause the processor to receive a web page from a community-generated web site, the web page associated with a particular piece of content, to extract a plurality of terms from the web page, to add the plurality of terms to content metadata associated with the piece of content, to extract specific category data from the content metadata, to load the specific category data into a category dataset, and reducing a dimensionality of the category dataset based on the category dataset and relation data, wherein the relation data defines a relationship between the category dataset and the content associated with the category dataset.

14. The system of claim 13, wherein extracting the plurality of terms further comprises at least one of stemming the terms in the web page, removing the stop terms from the web page, and extracting a limited number of terms from the web page.

15. The system of claim 13, wherein extracting the plurality of terms further comprises defining parser actions on the web page format.

16. The system of claim 13, wherein the metadata is category data.
